(19) United States
(12) Patent Application Publication
(10) Pub. No.: US 2023/0143875 A1
(43) Pub. Date: May 11, 2023

(54) DISTRIBUTION WHEEL AND PARTICULATE MATTER RELEASING APPARATUS

(71) Applicant: DONGGUAN LANGMENG INTELLIGENCE TECHNOLOGY CO, LTD., Dongguan (CN)

(72) Inventor: JINGYUAN WANG, Dongguan (CN)

(21) Appl. No.: 17/583,228

(22) Filed: Jan. 25, 2022

(30) Foreign Application Priority Data
Nov. 9, 2021 (CN) 202122739352.7

(51) Int. Cl. G01F 11/24

(52) U.S. Cl. CPC G01F 11/24

(57) ABSTRACT

The present disclosure provides a distribution wheel and a particulate matter releasing apparatus. The particulate matter releasing apparatus includes a distribution wheel and a driving member. The distribution wheel includes a circumferential surface and defines a recess on the circumferential surface. The recess is configured for receiving particulate matter. An opening size of the recess is less than a bottom size of the recess. The driving member is configured to drive the distribution wheel to rotate. In the present disclosure, the opening size of the recess may be less than the bottom size of the recess, so as to avoid a situation that the particulate matter within the recess falls out of the opening of the recess prematurely and cannot reach a preset position when the distribution wheel is rotated to a position where the opening of the recess is downward or obliquely downward.

### CROSS REFERENCE

The present application claims the priority of Chinese Patent Application No. 202122739352.7, filed on Nov. 9, 2021, which is entirely incorporated into the present disclosure by reference.

### TECHNICAL FIELD

The present disclosure relates to a technical field of pet supplies, and more particularly to a distribution wheel and a particulate matter releasing apparatus.

### BACKGROUND

More and more people enjoy feeding pets, and pets as friends of humans also greatly improve the quality of people's life.

The pet feeder in the related art generally includes a hopper, a distribution wheel, and an ejection assembly. The distribution wheel includes a circumferential surface which defines a recess. Pet food (which is in a particulate form) accommodated in the hopper may enter the recess when the distribution wheel is rotated to a position where an opening of the recess is upward or diagonally upward. The pet food in the recess drops onto a preset position when the distribution wheel is rotated to another position where the opening of the recess is downward or obliquely downward. And then the ejection assembly ejects the pet food dropped onto the preset position to feed the pet. However, in the related art, there is usually a problem that pet food falls out of the recess of the distribution wheel in advance, and cannot be delivered to the preset position smoothly.

### SUMMARY

The present disclosure provides a distribution wheel and a particulate matter releasing apparatus to solve a problem that pet food falls out of the recess of the distribution wheel in advance, and cannot be delivered to a preset position smoothly.

A first technical solution provided by the present disclosure is to provide a particulate matter releasing apparatus. The particulate matter releasing apparatus includes a distribution wheel and a driving member. The distribution wheel includes a circumferential surface and defines a recess on the circumferential surface. The recess is configured for receiving particulate matter. An opening size of the recess is less than a bottom size of the recess. The driving member is configured to drive the distribution wheel to rotate.

In the present disclosure, an opening size of the recess may be less than a bottom size of the recess, so as to avoid a situation that the particulate matter in the recess falls out of the opening of the recess prematurely and cannot reach a preset position when the distribution wheel is rotated to a position where the opening of the recess is downward or obliquely downward.

A second technical solution provided by the present disclosure is to provide a distribution wheel. The distribution wheel is configured to release particulate matter. The distribution wheel includes a circumferential surface and defines a recess on the circumferential surface. The recess is configured for receiving particulate matter. The recess includes a first side wall and a second side wall disposed oppositely to each other. The first side wall is in front of the second side wall in a rotational direction of the distribution wheel. A top end of the first side wall is located at an intersection of a first reference surface and a second reference surface. The first reference surface is a plane on which an opening of the recess is located. The second reference surface is perpendicular to the first reference surface. A remaining portion of the first side wall other than the top end is located at a side of the second reference surface away from the second side wall.

A third technical solution provided by the present disclosure is to provide a particulate matter releasing apparatus. The particulate matter releasing apparatus includes a driving member and a distribution wheel described above. The driving member is configured to drive the distribution wheel to rotate.

In the present disclosure, the remaining portion of the first side wall other than the top end is located at a side of the second reference surface away from the second side wall. When the distribution wheel is rotated to a position where the opening of the recess is downward or obliquely downward, the first side wall may retain the particulate matter in the recess to avoid a situation that the particulate matter falls out of the recess along the first side wall prematurely, and cannot reach a preset position.

### BRIEF DESCRIPTION OF THE DRAWINGS

In order to illustrate the technical solutions in the embodiments of the present disclosure or the prior art more clearly, the following will briefly introduce the figures needed to be used in the description of the embodiments or the prior art. Obviously, the drawings in the following description are only some embodiments of the present disclosure. Those skilled in the art may derive other figures from these figures without paying any creative work.

FIG. 1 is a structural schematic view of an embodiment of a particulate matter releasing apparatus of the present disclosure.

FIG. 2 is an exploded structural schematic view of the particulate matter releasing apparatus shown in FIG. 1.

FIG. 3 is a structural schematic view of a first housing shown in FIG. 2;

FIG. 4 is another exploded structural schematic view of the particulate matter releasing apparatus shown in FIG. 1.

FIG. 5 is a structural schematic view of a distribution wheel shown in FIG. 2.

FIG. 6 is a cross-sectional structural schematic view of the distribution wheel shown in FIG. 5 along line A-A.

FIG. 7 is the same view as FIG. 6.

FIG. 8 is the same view as FIG. 6.

FIG. 9 is the same view as FIG. 6.

FIG. 10 is the same view as FIG. 6.

FIG. 11 is the same view as FIG. 6.

FIG. 12 is an exploded structural schematic view of the distribution wheel shown in FIG. 5.

FIG. 13 is a schematic structural view of an embodiment of a distribution wheel in the related art.

### DETAILED DESCRIPTION

The technical solutions in the embodiments of the present disclosure will be described clearly and completely with reference to the figures in the embodiments of the present disclosure. Obviously, the described embodiments are only a part of the embodiments of the present disclosure, rather than all the embodiments. Based on the embodiments of the present disclosure, all other embodiments obtained by those skilled in the art without any creative work are within the scope of the present disclosure.

Mentioning “embodiments” herein means that a specific feature, structure, or characteristic described in conjunction with the embodiments may be included in at least one embodiment of the present disclosure. The appearances of the phrase in various places in the specification are not necessarily all referring to the same embodiment, nor are separate or alternative embodiments mutually exclusive of other embodiments. It is explicitly and implicitly understood by those skilled in the art that the embodiments described herein may be combined with other embodiments.

The terms “first”, “second”, and “third” in the embodiments of the present disclosure are only used for descriptive purposes, and cannot be understood as indicating or implying relative importance or implicitly indicating the number of indicated technical features. Thus, the features defined with “first”, “second”, and “third” may explicitly or implicitly include at least one of the features. In the description of the present application, “a plurality of” means at least two, e. g., two, three, etc., unless specifically defined otherwise. All directional indications (such as up, down, left, right, front, back) in the embodiments of the present disclosure are only used to account for relative positional relationships, motion conditions, etc., between components in a particular orientation (as shown in the drawings), if the particular orientation changed, correspondingly changes the directional indications. In addition, the terms “including” and “having” and any variations thereof are intended to cover non-exclusive inclusions. For example, a process, method, system, product, or device that includes a series of steps or units is not limited to the listed steps or units, but optionally includes unlisted steps or units, or optionally also includes other steps or units inherent to these processes, methods, products or equipment.

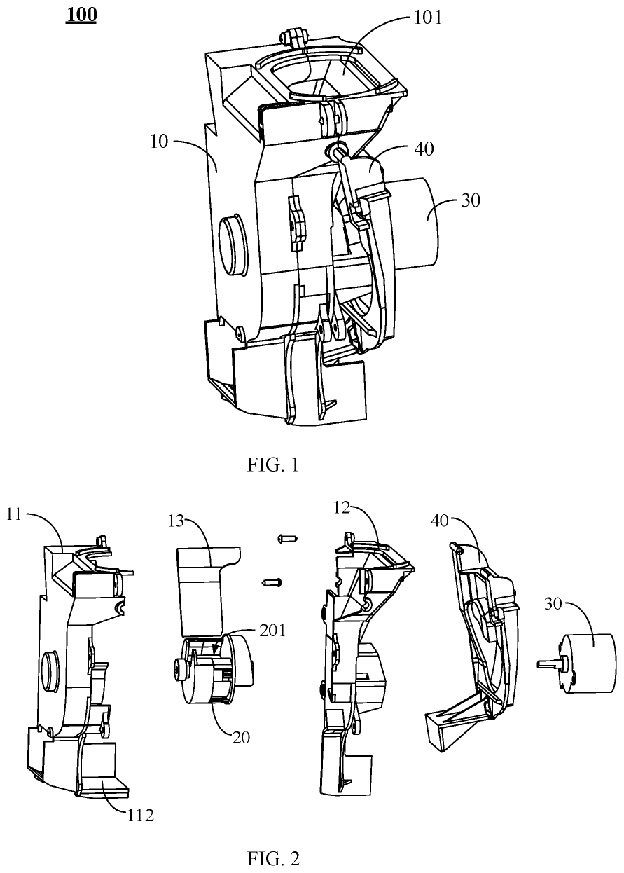

Please refer to FIG. 1 and FIG. 2. FIG. 1 is a structural schematic view of an embodiment of a particulate matter releasing apparatus of the present disclosure. FIG. 2 is an exploded structural schematic view of the particulate matter releasing apparatus shown in FIG. 1. The present disclosure provides a particulate matter releasing apparatus 100. The particulate matter releasing apparatus 100 includes an outer housing (which is not shown in the figures), an inner housing 10 disposed within the outer housing, a distribution wheel 20 disposed within the inner housing 10, a driving member 30 disposed within the outer housing and outside the inner housing 10, and a releasing assembly (which includes an ejection frame 40 and an ejection spring, wherein the ejection spring is not shown in the figures) disposed within the outer housing and outside the inner housing 10.

The outer housing is configured to protect components disposed therein. An upper portion of the inner housing 10 defines a hopper 101. The hopper 101 is configured to accommodate particulate matter. The distribution wheel 20 is disposed within an intermediate portion of the inner housing 10. The bottom of the inner housing 10 has a releasing platform 112. The driving member 30 is configured to drive the distribution wheel 20 to rotate. The distribution wheel 20 includes a circumferential surface and defines a recess 201 on the circumferential surface. The particulate matter in the hopper 101 may enter the recess 201 when the distribution wheel 20 is rotated to a position where an opening of the recess 201 is upward or diagonally upward. The particulate matter in the recess 201 falls onto the releasing platform 112 at the bottom of the inner housing 10 when the distribution wheel 20 is rotated to another position where the opening of the recess 201 is downward or obliquely downward. And then the releasing assembly releases the particulate matter falling onto the releasing platform 112 to feed the pet.

Next, a specific structure of the inner housing 10, the distribution wheel 20, the driving member 30, and the releasing assembly will be described in detail one by one.

<Inner Housing 10>

As shown in FIG. 2, the inner housing 10 includes a first shell 11, a second shell 12, and a baffle 13. An upper portion of the first shell 11 and an upper portion of the second shell 12 enclose to form the hopper 101. The hopper 101 is configured to accommodate the particulate matter. For example, the particulate matter may be pet foods in grain form, such as cookies or lyophilized meat products. The baffle 13 is disposed within the hopper 101 and is able to swing within the hopper 101.

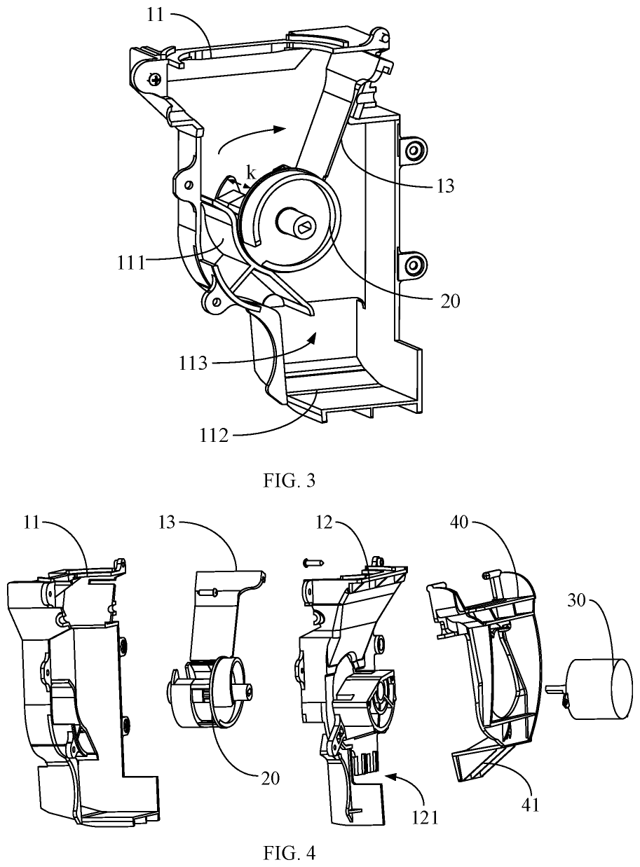

As shown in FIG. 3, FIG. 3 a structural schematic view of a first shell shown in FIG. 2. A direction indicated by an arrow in FIG. 3 is a rotational direction of the distribution wheel 20. An inner wall of the first shell 11 is provided with a guiding plate 111. A bottom portion of the first shell 11 is provided with a releasing platform 112. The opening of the recess 201 faces a feed opening of the hopper 101 when the distribution wheel 20 is rotated to a position where the opening of the recess 201 is upward or diagonally upward, such that the particulate matter in the hopper 101 may enter the recess 201 of the distribution wheel 20. The particulate matter received in the recess 201 may fall onto the releasing platform 112 under a guidance of the guiding plate 111 when the distribution wheel 20 is rotated to another position where the opening of the recess 201 is downward or obliquely downward. In addition, a lower portion of the first shell 11 also defines a first opening 113 corresponding to the releasing platform 112. The releasing assembly releases the particulate matter to feed the pet through the first opening 113.

As shown in FIG. 3, a width of the guiding plate 111 is equal to an axial width k of the recess 201, or the width of the guiding plate 111 is slightly greater than the axial width k of the recess 201, so that the particulate matter falling out of the recess 201 moves along the guiding plate 111 to reach the releasing platform 112, so as to prevent the particulate matter from falling to other positions out of the releasing platform 112.

As shown in FIG. 4, FIG. 4 is another exploded structural schematic view of the particulate matter releasing apparatus shown in FIG. 1. A lower portion of the second shell 12 defines an avoidance region 121 corresponding to the releasing platform 112. The avoidance region 121 is configured to avoid the releasing assembly from being interfered. The releasing assembly may apply a force to the particulate matter falling onto the releasing platform 112 through the avoidance region 121 to release the particulate matter falling onto the releasing platform 112.

The baffle 13 may be rotationally connected, such as hinged, to the first shell 11 and/or the second shell 12 to enable the baffle 13 to swing within the hopper 101. On one hand, a swing of the baffle 13 may toggle the particulate matter within the hopper 101 to avoid a situation that the particulate matter gets stuck in the hopper 101 and cannot enter the recess 201 of the distribution wheel 20. On the other hand, the swing of the baffle 13 may also help to avoid a situation that the particulate matter gets stuck between the baffle 13 and the distribution wheel 20.

The baffle 13 may have certain elasticity. The present disclosure do not limited a specific material of the baffle 13, and any one skilled in the art may choose depending on an actual requirements.

In some embodiments, the inner housing 10 may also be excluded by the particulate matter releasing apparatus 100. For example, there is only a channel, a conduit, or a container for guiding the particulate matter. In this situation, the distribution wheel may be fixed to the channel, the conduit, or the container described above directly or via a bracket.

<Distribution Wheel 20>

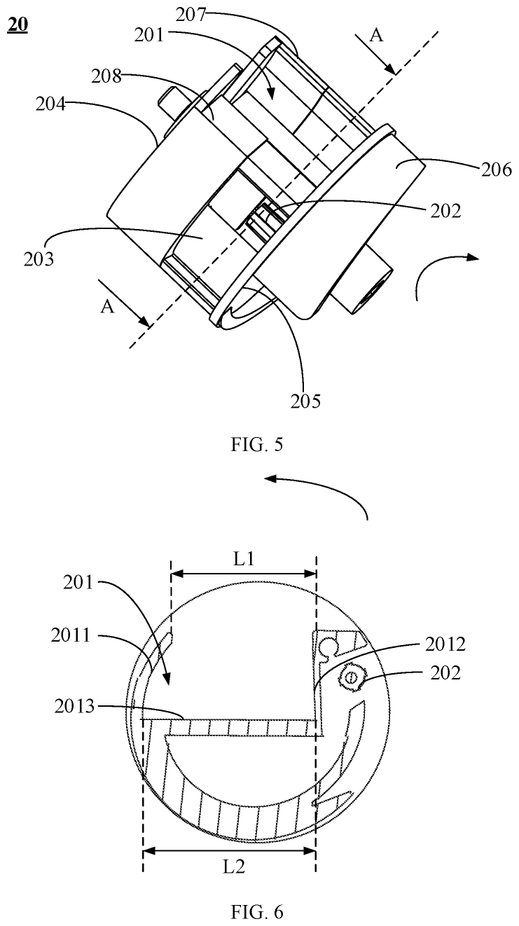

The distribution wheel 20 is configured to dispense the particulate matter within the hopper 101 to the releasing platform 112. Please refer to FIG. 5. FIG. 5 is a structural schematic view of the distribution wheel shown in FIG. 2. A direction indicated by an arrow in FIG. 5 is the rotational direction of the distribution wheel 20. The recess 201 is defined on the circumferential surface of the distribution wheel 20. The particulate matter within the hopper 101 may enter the recess 201 when the distribution wheel 20 is rotated to a position where the opening of the recess 201 is upward or diagonally upward. The particulate matter within the recess 201 falls onto the releasing platform 112 at the bottom of the inner housing 10 when the distribution wheel 20 is rotated to another position where the opening of the recess 201 is downward or obliquely downward.

Next, a shape of the recess 201 of the distribution wheel 20 will be described firstly.

In the embodiment, an opening size of the recess 201 may be less than a bottom size of the recess 201 to avoid a situation that the particulate matter in the recess 201 falls out of the opening of the recess 201 prematurely and cannot reach the releasing platform 112 when the distribution wheel 20 is rotated to a position where the opening of the recess 201 is downward or obliquely downward.

As shown in FIG. 6, FIG. 6 is a cross-sectional structural schematic view of the distribution wheel shown in FIG. 5 along line A-A. A direction indicated by an arrow in FIG. 6 is the rotational direction of the distribution wheel 20. In the embodiment, the opening size of the recess 201 is less than the bottom size of the recess 201 may refer to a situation that the opening size L1 of the recess 201 is less than the bottom size L2 of the recess 201 in the rotational direction of the distribution wheel 20 (i. e., in a rotational direction of a part of the distribution wheel 20 which defines the recess 201). In other words, a width of the opening L1 of the recess 201 is less than a width of the bottom L2 of the recess 201 in the rotational direction of the distribution wheel 20. In some embodiments, the opening size of the recess 201 is less than the bottom size of the recess 201 may also refer to a situation that the opening size of the recess 201 is less than the bottom size of the recess 201 in an axial direction of the distribution wheel 20 (i. e., a direction parallel to an axis of the distribution wheel 20). In other words, a width of the opening of the recess 201 is less than a width of the bottom of the recess 201 in the axial direction of the distribution wheel 20. In some embodiments, the opening size of the recess 201 is less than the bottom size of the recess 201 may also refer to a situation that the opening size L1 of the recess 201 is less than the bottom size L2 of the recess 201 in the rotational direction of the distribution wheel 20, and the opening size of the recess 201 is less than the bottom size of the recess 201 in the axial direction of the distribution wheel 20. The present disclosure is not limited thereto, and any one skilled in the art may choose according to actual needs.

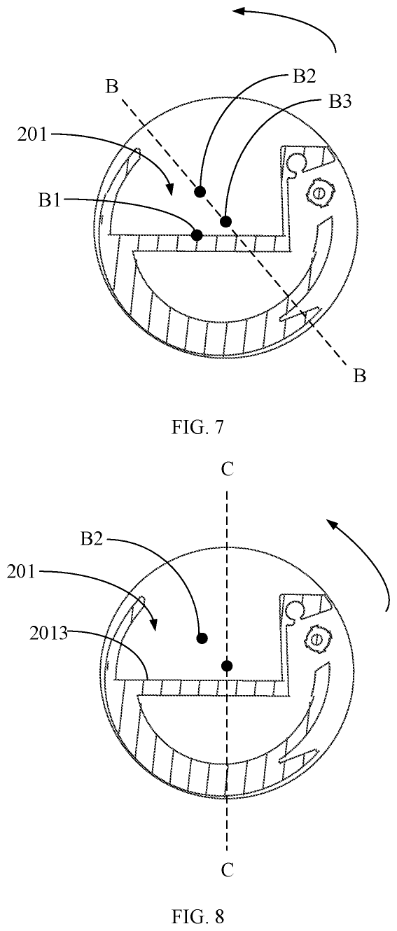

As shown in FIG. 7, FIG. 7 is the same view as FIG. 6. A direction indicated by an arrow in FIG. 7 is the rotational direction of the distribution wheel 20. In the embodiment, in a cross section of the distribution wheel 20 perpendicular to an axis of the distribution wheel 20, a bottom center B1 of the recess 201 is offset from a reference line B-B and is located at a front side of the reference line B-B in the rotational direction of the distribution wheel 20, so as to avoid a situation that the particulate matter within the recess 201 falls out of the opening of the recess 201 prematurely and cannot reach the releasing platform 112 when the distribution wheel 20 is rotated to a position where the opening of the recess 201 is downward or obliquely downward. The reference line B-B passes through a geometric center B2 of the recess 201 and an axial center B3 of the distribution wheel 20.

As shown in FIG. 7, in a case where the inner surface of the bottom wall 2013 is a plane surface, the bottom center B1 of the distribution wheel 20 may refer to a midpoint of a line segment corresponding to the inner surface of the bottom wall 2013. In a case where the inner surface of the bottom wall 2013 is a curved surface, the bottom center B1 of the distribution wheel 20 may also refer to a midpoint of an arc segment corresponding to inner surface of the bottom wall 2013 in a cross-sectional view of the distribution wheel 20 perpendicular to the axis of the distribution wheel 20. The present disclosure is not limited thereto, and any one skilled in the art may choose according to actual needs.

As shown in FIG. 8, FIG. 8 is the same view as FIG. 6. A direction indicated by an arrow in FIG. 8 is the rotational direction of the distribution wheel 20. In the embodiment, a bottom surface of the recess 201 is a plane (i. e., the inner surface of the bottom wall 2013 of the recess 201 is a plane). The geometric center B2 of the recess 201 is offset from a reference surface C-C, and is located on a front side of the reference surface C-C in the rotational direction of the distribution wheel 20, so as to avoid a situation that the particulate matter within the recess 201 falls out of the opening of the recess 201 prematurely and cannot reach the releasing platform 112 when the distribution wheel 20 is rotated to a position where the opening of the recess 201 is downward or obliquely downward. The reference surface C-C is an axial section of the distribution wheel 20 (i. e., a cross section of the distribution wheel 20 through the axis thereof) perpendicular to the bottom surface of the recess 201.

With continued reference to FIG. 6, in the embodiment, in the rotational direction of the distribution wheel 20 (i. e., on a cross section of the distribution wheel 20 perpendicular to the axis of the distribution wheel 20), the recess 201 may include a first side wall 2011 and a second side wall 2012 disposed oppositely to each other. The first side wall 2011 is in front of the second side wall 2012 in the rotational direction of the distribution wheel 20. That is, when the distribution wheel 20 is rotated to a position where the opening of the recess 201 is downward or obliquely downward, the particulate matter falls out of the recess 201 along the first side wall 2011, and moves along the guiding plate 111 to reach the releasing platform 112. In addition, the recess 201 may further include a bottom wall 2013 connecting the first side wall 2011 and the second side wall 2012.

In the embodiment, in a direction from the opening of the recess 201 to the bottom of the recess 201, the first side wall 2011 is gradually away from the second side wall 2012 to avoid a situation that the particulate matter within the recess 201 falls out of the opening of the recess 201 prematurely and cannot reach the releasing platform 112 when the distribution wheel 20 is rotated to a position where the opening of the recess 201 is downward or obliquely downward.

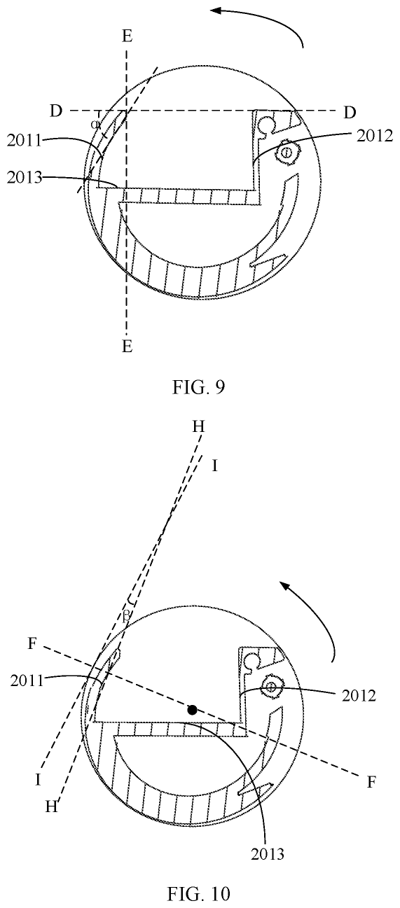

As shown in FIG. 9, FIG. 9 is the same view as FIG. 6. A direction indicated by an arrow in FIG. 9 is the rotational direction of the distribution wheel 20. In the embodiment, a top end of the first side wall 2011 is located at an intersection of a first reference surface D-D and a second reference surface E-E. The first reference surface D-D is a plane on which the opening of the recess 201 is located. In other words, the first reference surface D-D is flush with the opening of the recess 201. The second reference surface E-E is perpendicular to the first reference surface D-D. The remaining portion of the first side wall 2011 other than the top end is located at a side of the second reference surface E-E away from the second side wall 2012, so that when the distribution wheel 20 is rotated to a position where the opening of the recess 201 is downward or obliquely downward, the first side wall 2011 may retain the particulate matter in the recess 201 to prevent the particulate matter from falling out of the recess 201 along the first side wall 2011 prematurely.

Furthermore, as shown in FIG. 9, an inner surface of the first side wall 2011 is a curved surface. An angle α between a tangent plane of the inner surface of the first side wall 2011 and the first reference surface D-D is gradually increased in a direction away from the first reference surface. In this way, when the distribution wheel 20 is rotated to a position where the opening of the recess 201 is downward or obliquely downward, the first side wall 2011 may retain the particulate matter in the recess 201 better to ensure that the particulate matter within the recess 201 falls out of the recess 201 along the first side wall 2011, and then moves along the guiding plate 111 to reach the releasing platform 112. In some embodiments, the inner surface of first side wall 2011 may also be a straight surface. The present disclosure is not limited thereto, and any one skilled in the art may choose according to actual needs.

For example, the first side wall 2011 may extend along the circumferential surface of the distribution wheel 20 to retain the particulate matter in the recess 201 better when the distribution wheel 20 is rotated to a position where the opening of the recess 201 is downward or obliquely downward, so as to ensure that the particulate matter within the recess 201 falls out of the recess 201 along the first side wall 2011, and then moves along the guiding plate 111 to reach the releasing platform 112.

In order to reduce a processing difficulty of the distribution wheel 20, an inner surface of the second side wall 2012 and an inner surface of the bottom wall 2013 of the recess 201 may also be provided as straight surfaces to facilitate processing and molding. The present disclosure is not limited thereto. In some embodiments, the inner surface of the second side wall 2012 and the inner surface of the bottom wall 2013 may also be curved surfaces, and any one skilled in the art may choose according to actual needs.

In the embodiment, a depth of the recess 201 occupies 30%-60% of a diameter of the distribution wheel 20 to ensure that the particulate matter within the recess 201 may smoothly reach the releasing platform 112 without falling out of the recess 201 in advance. For example, the depth of the recess 201 may occupy 30%, 40%, 50%, or 60% of the diameter of the distribution wheel 20, which may be selected by any one skilled in the art according to actual needs. In a circumferential direction of the distribution wheel 20, a width of the opening of the recess 201 occupies 15%-35% of a circumference of the distribution wheel, so that particulate matter within the hopper 101 may enter into the recess 201 smoothly. For example, in the circumferential direction of the distribution wheel 20, the width of the opening of the recess 201 may occupy 15%, 20%, 25%, 30%, or 35% of the circumference of the distribution wheel 20, which may be selected by any one skilled in the art according to actual needs.

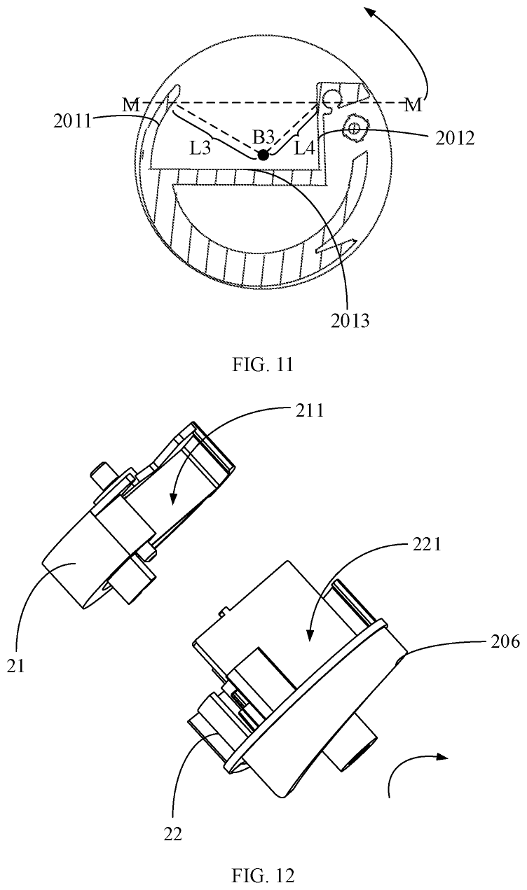

As shown in FIG. 10, FIG. 10 is the same view as FIG. 6. A direction indicated by an arrow in FIG. 10 is the rotational direction of the distribution wheel 20. In the embodiment, an angle β between a tangent plane I-I of the circumferential surface of the distribution wheel 20 relative to a axial section F-F of the distribution wheel 20 and a tangent plane H-H of the inner surface of the first side wall 2011 relative to a same axial section F-F of the distribution wheel 20 is between 0-20° (i. e., the inner surface of the first side wall 2011 runs along the circumferential surface of the distribution wheel 20 generally). At a same recess depth, a distance between the first side wall 2011 and an axis of the distribution wheel 20 has a first rate of change, a distance between the second side wall 2012 and the axis of the distribution wheel 20 has a second rate of change. As shown in FIG. 11, at a certain recess depth defined by a plane marked as M-M, the distance between the first side wall 2011 and the axis of the distribution wheel 20 is marked as L3. In other words, a first intersection line is defined by the plane marked as M-M and the inner surface of the first side wall 2011, the distance between the first side wall 2011 and the axis of the distribution wheel 20 refers to the distance between the first intersection line and the axis of the distribution wheel 20. The distance between the second side wall 2012 and the axis of the distribution wheel 20 is marked as L4. In other words, a second intersection line is defined by the plane marked as M-M and the inner surface of the second side wall 2012, the distance between the second side wall 2012 and the axis of the distribution wheel 20 refers to the distance between the second intersection line and the axis of the distribution wheel 20. The first rate of change is less than the second rate of change, so as to retain the particulate matter in the recess 201 when the distribution wheel 20 is rotated to a position where the opening of the recess 201 is downward or obliquely downward, to ensure that the particulate matter within the recess 201 falls out of the recess 201 along the first side wall 2011, and then moves along the guiding plate 111 to reach the releasing platform 112.

As shown in FIG. 10, in the embodiment, an angle β between a tangent plane I-I of the circumferential surface of the distribution wheel 20 relative to a axial section F-F of the distribution wheel 20 and a tangent plane H-H of the inner surface of the first side wall 2011 relative to a same axial section F-F of the distribution wheel 20 is between 0-20° (i. e., the inner surface of the first side wall 2011 runs along the circumferential surface of the distribution wheel 20 generally). At a first recess depth, a ratio of a distance between the first side wall 2011 and the axis of the distribution wheel 20 and a distance between the second side wall 2012 and the axis of the distribution wheel is recorded as a first distance ratio. At a second recess depth, a ratio of a distance between the first side wall 2011 and the axis of the distribution wheel 20 and a distance between the second side wall 2012 and the axis of the distribution wheel 20 is recorded as a second distance ratio. The first distance ratio is less than the second distance ratio, the first recess depth is greater than the second recess depth, so as to retain the particulate matter in the recess 201 when the distribution wheel 20 is rotated to a position where the opening of the recess 201 is downward or obliquely downward, to ensure that the particulate matter within the recess 201 falls out of the recess 201 along the first side wall 2011, and then moves along the guiding plate 111 to reach the releasing platform 112.

As shown in FIG. 6, in the embodiment, at a same recess depth, the distance between the first side wall 2011 and the axis of the distribution wheel 20 is greater than the distance between the second side wall 2012 and the axis of the distribution wheel 20. In other words, on the whole, the recess 201 is not symmetrical, but offset toward a front side of the rotational direction of the distribution wheel 20, so as to retain the particulate matter in the recess 201 when the distribution wheel 20 is rotated to a position where the opening of the recess 201 is downward or obliquely downward, to ensure that the particulate matter within the recess 201 falls out of the recess 201 along the first side wall 2011, and then moves along the guiding plate 111 to reach the releasing platform 112.

Next, the specific structure of the distribution wheel 20 will be described.

Please refer to FIG. 5 and FIG. 12. FIG. 12 is an exploded structural schematic view of the distribution wheel shown in FIG. 5. A direction indicated by an arrow in FIG. 12 is the rotational direction of the distribution wheel 20. Since the recess 201 defined on the distribution wheel 20 has a certain depth, it is difficult to manufacture the distribution wheel 20 directly. In the embodiment, the distribution wheel 20 may be assembled from a first seat 21 and a second seat 22. The first seat 21 defines a first groove 211. The second seat 22 defines a second groove 212. The first groove 211 and second groove 212 are communicated with each other to form the recess 201 together, so as to reduce the processing difficulty of the recess 201.

As shown in FIG. 5 and FIG. 12, in the rotational direction of the distribution wheel 20, the recess 201 defines a first edge 207 (i. e., an end of the first side wall 2011 away from the bottom wall 2013) and a second edge 208 (i. e., an end of the second side wall 2011 away from the bottom wall 2013) spaced apart from each other. The second edge 208 locates behind the first edge 207 in the rotational direction of the distribution wheel 20. A width of the second edge 208 is greater than a width of the first edge 207. The second edge 208 has a preset width to facilitate an assembly of the first seat 21 and the second seat 22.

As shown in FIG. 5, in the embodiment, a resilient member (which is not shown in the figures) is provided on the circumferential surface of the distribution wheel 20. The resilient member extends outward from the circumferential surface of the distribution wheel 20. During a rotation of the distribution wheel 20, the resilient member may interfere with the baffle 13, to drive the baffle 13 to swing within the hopper 101. As a result, the baffle 13 may perturb the particulate matter within the hopper 101 to prevent the particulate matter from blocking the feed opening of the hopper 101.

Specifically, the distribution wheel 20 may include two resilient members disposed symmetrically along the circumferential direction of the distribution wheel 20, such that the distribution wheel 20 oscillates at a fixed frequency during a rotation thereof. In some embodiments, the number of the resilient member may also be one, three, four, or even more. The present disclosure is not limited thereto, and any one skilled in the art may select according to actual circumstances.

In the embodiment, the elastic member may be a spring. As shown in FIG. 5, the circumferential surface of the distribution wheel 20 may be provided with a mounting post 202. The mounting post 202 may be inwardly recessed with respect to the circumferential surface of the distribution wheel 20. The spring (which is not shown on figures) may be set on the mounting post 202. An extension end of the spring extends outwardly to toggle the baffle 13, and drive the baffle 13 to swing within the hopper 101. In some embodiments, the resilient member may be other structures having certain elasticity, and capable of toggling the shutter 13. The present disclosure is not limited thereto, and any one skilled in the art may select according to actual needs.

Furthermore, as shown in FIG. 5, a receiving groove 203 is defined on the circumferential surface of the distribution wheel 20. The receiving groove 203 is corresponding to the spring. During a rotation of the distribution wheel 20, the extension end of the spring interferes with the guiding plate 111. When squeezed by the guiding plate 111, the extension end of the spring may be received in the receiving groove, to prevent the distribution wheel 20 from being jammed.

Please refer to FIG. 2 and FIG. 5 together. In the embodiment, the distribution wheel 20 includes a first end 204 and a second end 205 disposed oppositely to each other along an axial direction of the distribution wheel 20. The first end 204 is connected to the first shell 11. The second end 205 is connected to the driving member 30. The driving member 30 drives the distribution wheel 20 to rotate.

In the embodiment, an end surface of the second end 205 of the distribution wheel 20 is provided with an extending wall 206. The extending wall 206 extends outward from the end surface of the second end 205 in an axial direction of the distribution wheel 20. The extending wall 206 extends in the circumferential direction of the distribution wheel 20. In the rotational direction of the distribution wheel 20, a height of the extending wall 206 (i. e., the distance between an end of the extending wall 206 away from the end surface of the second end 205 and the end surface of the second end 205) decreases gradually first and then increases sharply. In other words, the extending wall 206 is disposed as a spiral line, to drive the release assembly to release the particulate matter on the release platform 112.

As mentioned above, in the embodiment, the driving member 30 is connected to the second end 205 of the distribution wheel 20 on which the extending wall 206 is provided. In some embodiments, the driving member 30 may also be connected to the first end 204. The present disclosure is not limited thereto, and any one skilled in the art may select according to actual needs.

In some embodiments, the extending wall 206 of the distribution wheel 20 may also be disposed in an involute manner with respect to an axis of the distribution wheel 20. In the rotational direction of the distribution wheel 20, a distance between the extending wall 206 and the axis of the distribution wheel 20 decreases gradually first and then increases sharply, to drive the release assembly to release the particulate matter on the release platform 112. The present disclosure is not limited thereto, and any one skilled in the art may select according to actual needs.

In some embodiments, the extending wall 206 may also be excluded from distribution wheel 20. For example, an end of the distribution wheel 20 may be connected with a cam. The cam rotates synchronously with the distribution wheel 20, to drive the releasing assembly to release the particulate matter on the releasing platform 112. The present disclosure is not limited thereto, and any one skilled in the art may select according to actual needs.

<Driving Member 30 and Releasing Assembly>

With continued reference to FIG. 2, the driving member 30 may be a motor. An output shaft of the driving member 30 is connected to the second end 205 of the distribution wheel 20, to drive the distribution wheel 20 to rotate. During a rotation of the distribution wheel 20, the extending wall 206 or the cam disposed on the second end 205 drive the releasing assembly to release the particulate matter on the releasing platform 112.

With continued reference to FIG. 2, in the embodiment, the releasing assembly may include an ejection frame 40 and an ejection spring (which is not shown in the figures). The ejection frame 40 is rotationally connected to the second shell 12, and may swing relative to the second shell 12, to move away from or close to the second shell 12. One end of the ejection spring is connected to the ejection frame 40. The other end of the ejection spring is connected to the outer housing.

During a rotation of the distribution wheel 20, the extending wall 206 of the second end 205 of the distribution wheel 20 may push the ejection frame 40 to swing in a direction away from the second shell 12, during which the ejection spring is compressed. Since the height of the extending wall 206 disposed on the second end 205 of the distribution wheel 20 decreases gradually first and then increases suddenly, when the ejection frame 40 swings to a preset magnitude in a direction away from the second shell 12, the pushing force from the distribution wheel 20 disappears suddenly, the ejection spring drives the ejection frame 40 to swing back (i. e., the ejection frame 40 swing towards the second shell 12), a baffle 41 disposed at a bottom of the ejection frame 40 extends into the inner housing 10 via the avoidance region 121 defined by the second shell 12, to eject the particulate matter on the releasing platform 112 from the first opening 113 of the first shell 11.

Specific structures of the particulate matter releasing apparatus 100 provided by the present disclosure are described above in detail. In addition, the inventor also designs tests to compare the feeding effect of the distribution wheel provided by the present disclosure with the distribution wheel in the related art.

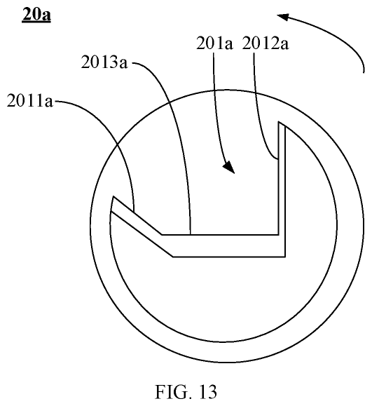

Please refer to FIG. 13. FIG. 13 is a schematic structural view of an embodiment of a distribution wheel in the related art. A direction indicated by an arrow in FIG. 13 is the rotational direction of the distribution wheel 20a. The recess 201a of the distribution wheel 20a in the related art also includes a first wall 2011a, a second wall 2012a, and a bottom wall 2013a connecting the first wall 2011a and second side wall 2012a, but the specific structure is different from the present disclosure.

Specifically, as shown in FIG. 13, an opening size of the recess 201a is larger than a bottom size of the recess 201a in the rotational direction of the distribution wheel 20a (i. e., in a rotational direction of a part of the distribution wheel 20a which defines the recess 201a). A size of the recess 201a gradually decreases from the opening of the recess 201a to the bottom of the recess 201a.

The distribution wheel 20 shown in FIG. 5 and the distribution wheel 20a shown in FIG. 13 are used to carry out feeding tests on two kinds of pet snacks sold in the markets by control variables.

Among them, one kind of the pet snacks is pet cookies, which are brittle cookie products with a size of 28.5 mm*12.2 mm*6.6 mm. The other kind of the pet snacks is lyophilized snacks, which are dehydrated meat products with certain resilience. The lyophilized snacks has a size of 13.3 mm*13.0 mm*10.0 mm.

One experimental statistical index is a number of the particulate matter taken out of the hopper by the distribution wheel at every time. Under ideal conditions, the number of the particulate matter taken out by the distribution wheel at every time should be consistent. The other experimental statistical index is a number of the particulate matter remaining on the releasing platform without being ejected out by the releasing assembly. Under ideal conditions, there should be no particulate matter remaining on the releasing platform. However, in practice, the shape of the recess may cause the distribution wheel to take too much particulate matter out of the hopper, as a result, the releasing assembly cannot eject all the particulate matter out, and a part of the particulate matter is remaining on the releasing platform.

The results of the statistical indexes of the 50 feeding tests on the pet cookies are shown in the table below:

| | The variance of the number | The average number of the |
|---|---|---|
| | of the particulate matter | particulate matter retaining |
| Distribution | taken by the distribution | on the releasing platform |
| wheel | wheel of 50 feeding tests | of 50 feeding tests |
| Distribution | 1.4384 | 0.6 |
| wheel 20a of | | |
| the related | | |
| art (as shown | | |
| in FIG. 13) | | |
| Distribution | 0.5065 | 0.28 |
| wheel 20 of | | |
| the present | | |
| disclosure (as | | |
| shown in | | |
| FIG. 5) | | |

It can be obtained from the analysis of experimental data shown above that:

The distribution wheel of the present disclosure has a lower variance of the number of the particulate matter taken by the distribution wheel, indicating that the number of the particulate matter taken by the distribution wheel has a small fluctuation in multiple feeding tests. In addition, the average number of the particulate matter retaining on the releasing platform of the distribution wheel of the present disclosure is also less than the distribution wheel of the related art.

The results of the statistical indexes of the 50 feeding tests on the lyophilized snacks are shown in the table below:

| | The variance of the number | The average number of the |
|---|---|---|
| | of the particulate matter | particulate matter retaining |
| Distribution | taken by the distribution | on the releasing platform |
| wheel | wheel of 50 feeding tests | of 50 feeding tests |
| Distribution | 1.4894 | 0.64 |
| wheel 20a of | | |
| the related | | |
| art (as shown | | |
| in FIG. 13) | | |
| Distribution | 0.3792 | 0.22 |
| wheel 20 of | | |
| the present | | |
| disclosure (as | | |
| shown in | | |
| FIG. 5) | | |

It can be obtained from the analysis of experimental data shown above that:

The distribution wheel of the present disclosure has a lower variance of the number of the particulate matter taken by the distribution wheel, indicating that the number of the particulate matter taken by the distribution wheel has a small fluctuation in multiple feeding tests. In addition, the average number of the particulate matter retaining on the releasing platform of the distribution wheel of the present disclosure is also less than the distribution wheel of the related art.

To sum up, for commonly used pet snacks, the performance of the distribution wheel of the present disclosure is better than the distribution wheel of the related art on both the evenness of the number of the particulate matter taken by the distribution wheel and whether the particulate matter is easy to be remained on the releasing platform.

The above description are only embodiments of the present disclosure, and do not limit the scope of the present disclosure. Any equivalent structure or equivalent process transformation made by using the contents of the description and drawings of the present disclosure, or directly or indirectly used in other related technical fields, are similarly included in the scope of patent protection of the present disclosure.

What is claimed is:

1. A particulate matter releasing apparatus comprising:
a distribution wheel comprising a circumferential surface and defining a recess on the circumferential surface, the recess being configured for receiving particulate matter, an opening size of the recess being less than a bottom size of the recess; and
a driving member configured for driving the distribution wheel to rotate.

2. The particulate matter releasing apparatus of claim 1, wherein in a rotational direction of the distribution wheel, the opening size of the recess is less than the bottom size of the recess.

3. The particulate matter releasing apparatus of claim 1, wherein in a cross section of the distribution wheel perpendicular to an axis of the distribution wheel, a bottom center of the recess is offset from a reference line and is located at a front side of the reference line in a rotational direction of the distribution wheel, and the reference line is a radial line of the distribution wheel which extends through a geometric center of the recess.

4. The particulate matter releasing apparatus of claim 1, wherein a bottom surface of the recess is a plane, a geometric center of the recess is offset from a reference surface, and is located at a front side of the reference surface in a rotational direction of the distribution wheel, and the reference surface is an axial section of the distribution wheel perpendicular to the bottom surface.

5. The particulate matter releasing apparatus of claim 1, wherein in a rotational direction of the distribution wheel, the recess comprises a first side wall and a second side wall disposed oppositely to each other, the first side wall is in front of the second side wall in the rotational direction of the distribution wheel, and the first side wall gradually extends away from the second side wall in a direction close to a bottom of the recess.

6. The particulate matter releasing apparatus of claim 1, wherein the distribution wheel comprises a first seat and a second seat, the first seat defines a first groove, the second seat defines a second groove, the first seat and the second seat are assembled to form the distribution wheel together, and the first groove and second groove are communicated with each other to form the recess together.

7. The particulate matter releasing apparatus of claim 6, wherein in a rotational direction of the distribution wheel, the recess defines a first edge and a second edge spaced apart from each other, the second edge locates behind the first edge in the rotational direction of the distribution wheel, and a width of the second edge is greater than a width of the first edge.

8. A distribution wheel configured to release particulate matter, comprising a circumferential surface and defining a recess on the circumferential surface, the recess being configured for receiving particulate matter, the recess comprising a first side wall and a second side wall disposed oppositely to each other, the first side wall being in front of the second side wall in a rotational direction of the distribution wheel;
and wherein a top end of the first side wall is located at an intersection of a first reference surface and a second reference surface, the first reference surface is a plane on which an opening of the recess is located, the second reference surface is perpendicular to the first reference surface, and a remaining portion of the first side wall other than the top end is located at a side of the second reference surface away from the second side wall.

9. The distribution wheel of claim 8, wherein an inner surface of the first side wall is a curved surface, an angle between a tangent plane of the inner surface of the first side wall and the first reference surface is gradually increased in a direction away from the first reference surface.

10. The distribution wheel of claim 9, wherein the recess further comprises a bottom wall connecting the first side wall and the second side wall, an inner surface of the second side wall and an inner surface of the bottom wall are straight surfaces.

11. The distribution wheel of claim 8, wherein in a cross section of the distribution wheel perpendicular to an axis of the distribution wheel, an opening size of the recess is less than a bottom size of the recess.

12. The distribution wheel of claim 8, wherein a depth of the recess occupies 30%-60% of a diameter of the distribution wheel, and in the rotational direction of the distribution wheel, a width of the opening of the recess occupies 15%-35% of a circumference of the distribution wheel.

13. The distribution wheel of claim 8, wherein a resilient member is provided on the circumferential surface of the distribution wheel, the resilient member extends outward from the circumferential surface of the distribution wheel.

14. The distribution wheel according to claim 13, wherein the distribution wheel defines a receiving groove on the circumferential surface corresponding to the resilient member, during a rotation of the distribution wheel, the elastic member is able to be received in the receiving groove to prevent the distribution wheel from being jammed.

15. The distribution wheel of claim 8, wherein an end surface of the distribution wheel is provided with an extending wall, the extending wall extends outward from the end surface in an axial direction of the distribution wheel, the extending wall extends in a circumferential direction of the distribution wheel, and a height of the extending wall decreases gradually first and then increases in the rotational direction of the distribution wheel.

16. The distribution wheel of claim 8, wherein an end surface of the distribution wheel is provided with an extending wall, the extending wall extends outward from the end surface in a direction parallel to an axis of the distribution wheel, the extending wall is disposed in an involute manner with respect to an axis of the distribution wheel.

17. A particulate matter releasing apparatus comprising a driving member and a distribution wheel of claim 8, the driving member being configured to drive the distribution wheel to rotate.

18. The particulate matter releasing apparatus of claim 17, wherein the particulate matter releasing apparatus further comprises a hopper configured to accommodate the particulate matter, the recess is configured for catching the particulate matter falling out of the hopper, and then dropping the particulate matter out of the recess when the distribution wheel is rotated to a position where an opening of the recess is downward or obliquely downward; an angle between a tangent plane of the circumferential surface of the distribution wheel relative to a axial section of the distribution wheel and a tangent plane of an inner surface of the first side wall relative to a same axial section of the distribution wheel is between 0-20°; at a same recess depth, a distance between the first side wall and an axis of the distribution wheel has a first rate of change, a distance between the second side wall and the axis of the distribution wheel has a second rate of change, the first rate of change is less than the second rate of change.

19. The particulate matter releasing apparatus of claim 17, wherein the distribution wheel is configured to drop the particulate matter out of the recess when the distribution wheel is rotated to a position where an opening of the recess is downward or obliquely downward; the particulate matter releasing apparatus further comprises a releasing assembly configured to release the particulate matter falling out of the recess; at a same recess depth, a distance between the first side wall and an axis of the distribution wheel is greater than a distance between the second side wall and the axis of the distribution wheel.

20. The particulate matter releasing apparatus of claim 17, wherein the particulate matter releasing apparatus further comprises a driving member configured to drive the distribution wheel to rotate; an angle between a tangent plane of the circumferential surface of the distribution wheel relative to a axial section of the distribution wheel and a tangent plane of an inner surface of the first side wall relative to a same axial section of the distribution wheel is between 0-20°; at a first recess depth, a ratio of a distance between the first side wall and an axis of the distribution wheel and a distance between the second side wall and the axis of the distribution wheel is recorded as a first distance ratio; at a second recess depth, a ratio of a distance between the first side wall and the axis of the distribution wheel and a distance between the second side wall and the axis of the distribution wheel is recorded as a second distance ratio; the first distance ratio is less than the second distance ratio, and the first recess depth is greater than the second recess depth.
